(19) United States
(12) Patent Application Publication
(10) Pub. No.: US 2010/0175182 A1
(43) Pub. Date: Jul. 15, 2010

(54) MANUFACTURING PROCESS OF WORK TOP WITH SINK

(75) Inventors: Masanori Konno, Tokyo (JP); Kazuhiro Okada, Tokyo (JP); Akihiko Ogata, Tokyo (JP); Junji Nagase, Tokyo (JP)

Correspondence Address: Silicon Valley Patent Group LLP;Attn: Bryan Wyman, 18805 Cox Avenue, Suite 220, Saratoga, CA, 95070, US

(73) Assignee: CLEANUP CORPORATION, Tokyo (JP)

(21) Appl. No.: 12/667,032

(22) PCT Filed: Jun. 9, 2008
(86) PCT No.: PCT/JP2008/060531

§ 371 Date: Feb. 16, 2010

(30) Foreign Application Priority Data
Jul. 4, 2007 (JP) 2007-176814

(51) Int. Cl. A47B 77/06; B23P 25/00

(52) U.S. Cl. 4/630; 29/458

(57) ABSTRACT

The manufacturing process of work top with sink including a work top 120 and a sink 122 stuck together comprises: a work top forming step 10; and a sink forming step 30 in which a sink forming uneven mold is attached to a sink opening 121a formed in the work top 120 and resin is injected into the uneven mold whereby the sink is formed and simultaneously stuck to the sink opening (FIG. 1).

### CROSS-REFERENCE TO RELATED APPLICATIONS

This application is the National Stage under 35 U.S.C. 371 of International Application No. PCT/JP2008/060531, filed on Jun. 9, 2008, which claims the benefit of Japanese Patent Application Serial No. JP 2007-176814, filed on Jul. 4, 2007. The contents of both of the foregoing applications are hereby incorporated by reference in their entireties.

### BACKGROUND OF THE INVENTION

The present invention relates to a manufacturing process of work top with sink which forms a part of a system kitchen, especially to the process for forming and joining a work top and a sink together as one body.

Today, a system kitchen has been provided and widely spread. A system kitchen comprises under a work top (top board) several sections such as a sink, a cooking stove and a cabinet. The work top is a top board arranged on the top of a system kitchen and covering a sink, a cooking stove and a working space. A sink has to be stuck to or formed as one body with the work top in order to prevent a water leak.

In recent yeas, a work top with sink made of resin so-called artificial marble is widely spread since it has a good appearance. Such a work top with sink is formed as if it is one body. A recent question to be solved is how to provide a beautiful work top with sink and how to establish an efficient manufacturing process for such a work top.

In order to solve the above question, one method to form a work top and a sink as one body is proposed. However, a work top is a large plate of a width of 2 . . . 3 m. A sink's width is narrower but it has a three-dimensional vessel form. So, a mold capable of forming a work top and a sink at the same time as one body must be large, complicated and expensive. Besides, because of a difference of thickness and required hardness between a work top and of a sink, a material resin and setting time for them are not always the same. Moreover, a work top and a sink has an even, uniform and parochial appearance. Due to those problems, a reasonable method for forming a large work top with a sink at the same time as one body is still needed.

Various solutions have been proposed in the past for a work top with sink forming a part of a system kitchen. Patent Document 1 discloses a counter made of artificial marble. The counter includes a work top (counter made of artificial marble) and a sink (concave part) adhering together by a bond and the adhesive surface of them is chamfered. Patent Document 2 describes that an appearance and hygiene of a kitchen is improved by eliminating an overhang part thereof.

Patent Document 1: Japan Laid Open Patent H11-123114 (Patent No. 3345320)

As stated above, forming a work top and a sink by a single mold at the same time would cause problems that the mold would have a large and complicated structure, that it would be difficult to choose a material resin and a setting time of the molded sink, and that the appearance of the molded sink would have an even and uniform appearance.

On the other hand, when forming a work top and a sink independently and sticking them together as described in Patent Document 1, additional processes such as sticking and polishing adhesive surfaces of them are required. It results in an increase of the number of processes for manufacturing. Besides, it may be paradoxical, but this method would cause an impression of isolation of a work top and a sink so that it would hurt a sense of beauty of one body of the kitchen.

Accordingly, the object of the present invention is to provide a work top with sink of a good appearance by forming a work top and a sink as one body without using a large and complicated mold and without losing a degree of design freedom of them.

### SUMMARY

In order to solve the above stated problems, according to an aspect of the present invention, a manufacturing process of work top with sink including a work top and a sink stuck together comprising: a step for forming work top; and a step for forming sink in which a sink forming uneven mold is attached to a sink opening formed in the work top and resin is injected into the uneven mold whereby the sink is formed and simultaneously stuck to the sink opening.

In said step for forming sink, the peripheral edge of the sink opening may be nipped by the sink forming uneven mold.

In said step for forming sink, when attaching the sink forming uneven mold to the work top, a convex mold may be directly attached to the outside of the work top and a concave mold may be attached via a sealing element for preventing a resin leak to the inside of the work top.

In said step for forming sink, it is preferable to position the sink-side end of the sealing element for preventing a resin leak 1 mm or more outer than the end of the sink opening.

Said step for forming work top may further comprise a sub-step for cutting the inside peripheral edge of the sink opening so that the thickness of sink opening is almost equal, and in said step for forming sink the sealing element for preventing a resin leak may be attached to the inside peripheral edge of the sink opening cut to be almost equal thickness and flat by said sub-step for cutting.

According to another aspect of the present invention, a work top with sink including a work top and a sink stuck together wherein a resin for forming said sink is attached directly to said work top, and said sink is attached to said work top at the end and the inside peripheral edge of the sink opening formed in said work top.

At the attached part of said work top and said sink, said sink may have a flange attached to the inside of the sink opening.

At the attached part of said work top and said sink, the inside peripheral edge of the sink opening may have an almost equal thickness and may be flat.

Said sink may have at least one feature, selected from color, pattern, material or surface form, different from that of said work top.

Said sink may have at least one feature, selected from color, pattern, material or surface form, almost the same as that of said work top.

According to the present invention, when manufacturing a work top with sink by double molding, compared with a conventional method wherein a work top and a sink are formed independently and stuck together afterward, the required working accuracy for the attached part of the sink and the work top can be reduced, a step for sticking can be eliminated, material cost for a cutting margin of sink can be saved, and the appearance of the attached part can be improved. Besides, compared with a conventional method wherein a sink and a work top are formed as one body, the cost for a mold can be saved since a mold of smaller size can be used, and a space for locating the mold can be reduced. That is to say, a work top with sink of a good appearance can be provided by forming a work top and a sink as one body without using a large and complicated mold and without losing a degree of design freedom of them.

### BRIEF DESCRIPTION OF THE DRAWINGS

FIG. 1 shows a flowchart illustrating the manufacturing process of work top with sink according to the embodiment of the invention.

FIG. 2 shows a longitudinal end view of the work top forming mold.

FIG. 3 shows a perspective view of the formed work top.

FIG. 4 shows a perspective view of the work top after the cutting step.

FIG. 5 shows a lateral end view of the sink forming mold which is set in position.

FIG. 6 shows a perspective view of the formed work top with sink.

FIG. 7 shows a lateral sectional view of a formed work top with sink.

FIG. 8 shows a view for illustrating variations of the work top.

### DETAILED DESCRIPTION OF THE INVENTION

Explanation of reference numerals:

10 work top forming step

20 cutting step

30 sink forming step

100 work top forming mold

101 work top forming lower mold

102 work top forming upper mold

110 sink forming mold

111 lower mold

112 upper mold

112a air vent hole

112b injection hole

116 gasket

120, 121 work top

121a opening

121c end part

121d inside peripheral edge

121e slope

121f step part

122 sink

122a flange

122b upper end

124 work top with sink

130 attached part

The best embodiment for realizing the present invention will be explained in detail below with reference to the accompanying drawings. The present invention is not limited to the following embodiment with specific sizes, quality of materials and numerals which are only examples described for making the invention understood easily. In the present description and drawings, the structural elements which have essentially the same functional structure are indicated by the same reference numerals in order to omit overlapping explanations.

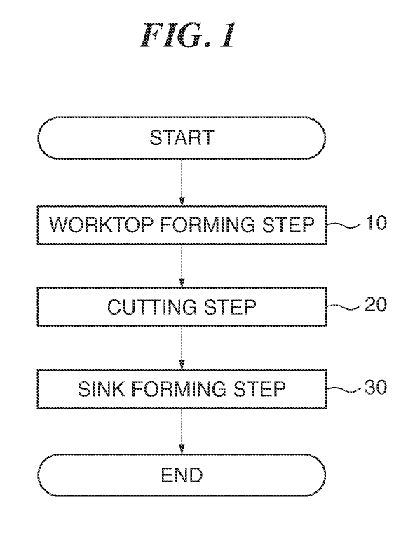

The manufacturing process of work top with sink according to the embodiment is applied to a system kitchen in which watery kitchen facilities such as a sink are functionally formed as one body. FIG. 1 shows a flowchart illustrating the manufacturing process of work top with sink according to the embodiment of the invention. As shown in FIG. 1, the manufacturing process of work top with sink comprises a work top forming step 10, a cutting step 20 and a sink forming step 30. Each step will be explained in detail below.

In the work top forming step 10, initially, a setting agent, a coloring agent and a pattern material are added to a thermosetting resin for a material of work top. The thermosetting resin is then agitated and degassed. The thermosetting resin can be one or a combination for example of unsaturated polyester resin, vinyl ester resin, methacrylate prepolymer containing triazine ring, methyl methacrylate resin. On the other hand, the setting agent can be organic peroxides, for example. The coloring agent can be, in view of waterproofing, heat-resistance and lightfastness, inorganic pigments or solid resin colored by inorganic pigments in the form of powder, for example.

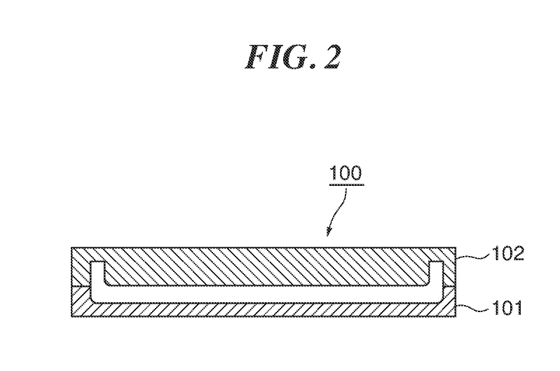

Subsequently, a work top forming mold 100 made of metal or reinforced plastic is set in position. As shown in FIG. 2, the work top forming mold 100 comprises a work top forming lower mold (hereinafter referred to as “lower mold 101”) and a work top forming upper mold (hereinafter referred to as “upper mold 102”).

When injecting liquid thermosetting resin, initially an air vent tube is set to the work top forming mold 100 in order to degas the mold. Then a setting agent, a coloring agent, a pattern material are added to the thermosetting resin. Subsequently, the thermosetting resin is agitated, degassed and injected from a tank to the work top forming mold 100. After filling up the work top forming mold 100 with the thermosetting resin, the mold 100 is heated for a predetermined time for setting the resin and then opened. Finally, a formed work top 120 is taken out of the work top forming mold 100.

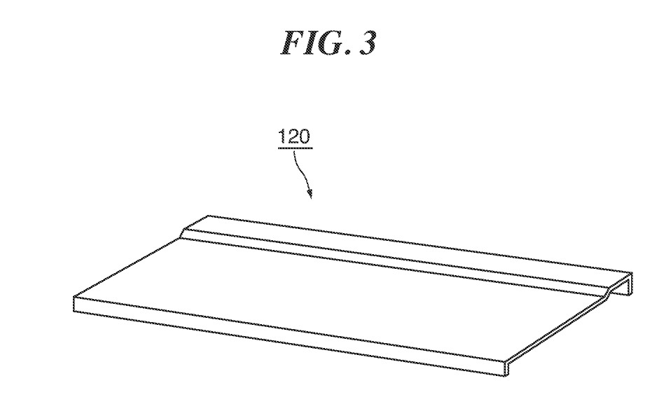

FIG. 3 shows a perspective view of the formed work top. The formed work top 120 is transferred to the subsequent cutting step 20. In the cutting step 20, it is mainly carried out to form a sink opening 121a (hereinafter referred to as “opening 121a”) and a cooking stove opening 121b (hereinafter referred to as “opening 121b”), and to scrape with a router the inside peripheral edge of the opening 121a so that the thickness of peripheral edge of the opening 121a is almost equal.

The work top 120 is formed flat in its outside which was facing downward in the mold 100, but it is formed rough in its inside which was facing upward in the mold 100. Therefore, the thickness of the work top 120 is not equal. The unequalness of thickness may cause, in the sink forming step, a gap between the sealing element for preventing a resin leak and the work top 120. Such a gap causes a resin leak and the unequalness of the thickness of the sink. So, in the subsequent cutting step 20, the peripheral edge of the opening 121a forming a part of the sink is made flat and the thickness of the work top is made equal. When cutting the work top, a known NC (Numerical Control machining) tool may be used.

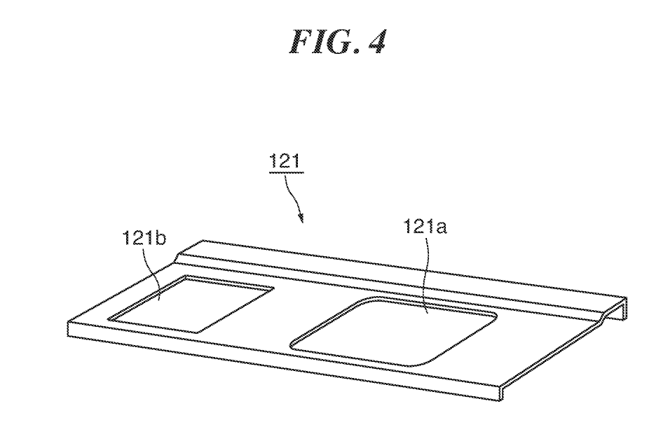

FIG. 4 shows a perspective view of the work top after the cutting step. After cutting the work top 121, it is transferred to the sink forming step 30.

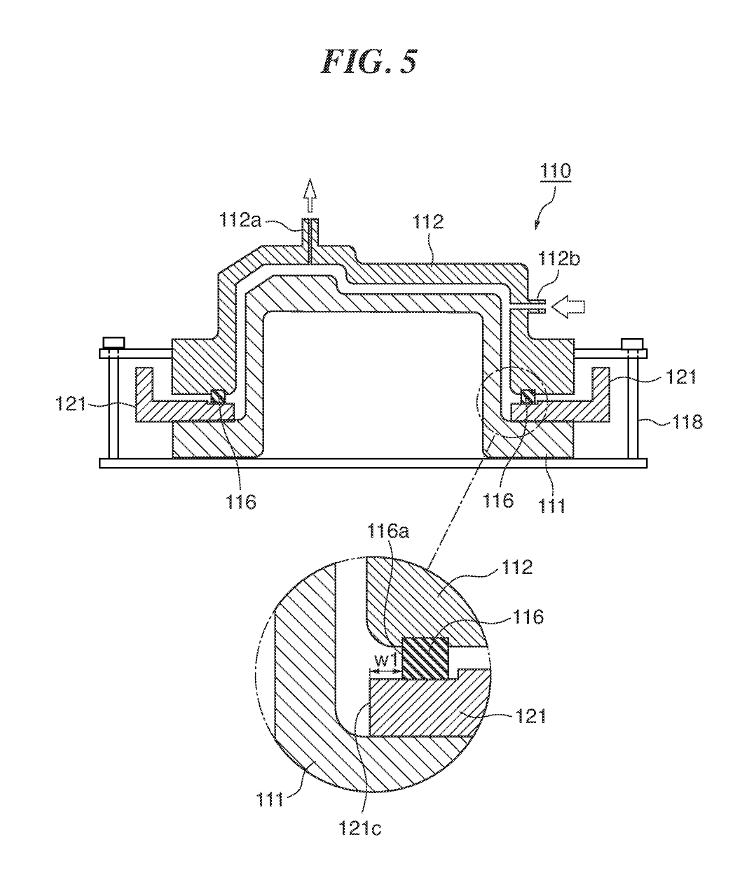

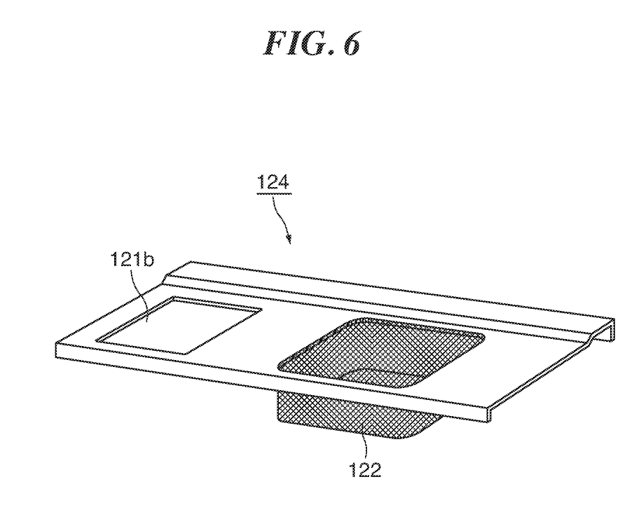

FIG. 5 shows a lateral end view of the sink forming mold which is set in position. In the sink forming step 30, the sink forming mold 110 is set to the work top 121 in which the peripheral edge of opening 121a was scraped in the cutting step 20. Then the sink 122 is formed by injection molding so that the work top 121 and the sink 122 are formed as one body (see FIG. 6). FIG. 6 shows a perspective view of the formed work top with sink 124.

In the sink forming step 30, initially, a setting agent, a coloring agent and a pattern material are added to a thermosetting resin for a material of sink. The material of the sink 122 such as a thermosetting resin may be the same as or different from that of the work top 120. Subsequently, a sink forming mold 110 made of metal or reinforced plastic is set in position to the opening 121a formed in the work top 121. As shown in FIG. 5, the sink forming mold 110 is comprised of a sink forming convex lower mold (hereinafter referred to as “lower mold 111”) and a sink forming concave upper mold (hereinafter referred to as “upper mold 112”). The work top 121 is set so that its outside faces downward. Then from the lower side of the work top 121 the lower mold 111 is put into the opening 121a, and from the upper side i.e. on the inside of the work top 121 the upper mold 112 is set in position.

The lower mold 111 is directly attached to the work top 121. The bottom surface (outside) of the work top 121 is formed flat. Therefore, a gap can be sealed by pressing the lower mold 111 against the bottom surface of the work top. On the other hand, a rubber gasket 116 as a sealing element is attached to the upper mold 112 at the inside peripheral edge (at the scraped position in the cutting step 20) of the opening 121a formed in the work top 121 in order to prevent a resin leak in forming process. The upper mold 112 is set in position so that the gasket 116 is attached to the inside peripheral edge of the opening 121a. The sink-side end 116a of the gasket 116 is positioned outer than the end part 121c of the opening 121a. The width w1 (see the partial enlarged view of FIG. 5) is 1 mm or more preferably. After pressing the lower mold 111, the lower mold 111 and the upper mold 112 are secured with a cramp 118.

Subsequently, an air vent tube for degassing the mold when injecting a resin in to the mold is set to the air vent hole 112a of the sink forming mold 110. After that, a setting agent, a coloring agent and a pattern material are added to thermosetting resin for a material of sink. The thermosetting resin is then agitated, degassed and injected from a tank through the injection hole 112b of the sink forming mold 110. After filling up the sink forming mold 110 with the thermosetting resin, the mold 110 is heated for a predetermined time for setting the resin. The mold 110 is then cooled for a predetermined time, the air vent tube is removed and the mold 110 is opened. Finally, a formed sink 122 is taken out of the sink forming mold 110.

According to the structure of the embodiment stated above, since the gasket 116 attached to the sink forming upper mold 112 is further attached to the flat-formed inside peripheral edge of the opening 121a, when injecting the thermosetting resin into the sink forming mold 110, the thermosetting resin can be prevented from leaking from the inside of the work top 121.

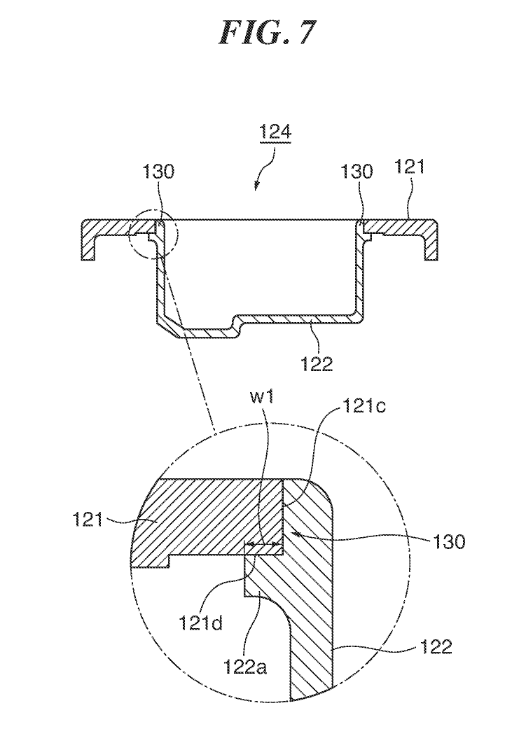

As shown in FIG. 7, since the sink-side end of the gasket 116 is positioned 1 mm or more (width w1 in FIG. 5) outer than the end part of the opening 121a, the attached part 130 is created, in addition to the end part 121c of the opening 121a formed in the work top 121, at the inside peripheral edge 121d continuous from the end part 121c. That is to say, when observing the sink 122 only, a flange 122a of width w1 is formed along the opening 121a of the work top 121. In other words, the attached part 130 includes a corner formed by the sink 122 from the end part 121c of the work top 121 to the inside peripheral edge 121d. Because of the corner, the adhesive area between the work top 121 and the sink 122 is increased and therefore the adhesion strength between the work top 121 and the sink 122 is improved. As a result, the sink 122 can stand sufficiently even in the case of loading a heavy object onto the sink 122 and filling up the sink 122 with water.

According to the embodiment of the invention, compared with a conventional method wherein a work top and a sink are formed independently and stuck together afterward, since the resin for forming the sink is directly attached to the work top, the required working accuracy for the attached part of the sink and the work top can be reduced, a step for sticking can be eliminated, material cost for a cutting margin of sink can be saved, and the appearance of the attached part can be improved.

Besides, compared with a conventional method wherein a sink and a work top are formed as one body, the cost for a mold can be saved since a mold of smaller size can be used, and a space for locating the mold can be reduced. Moreover, since the conditions such as a material resin and a setting time can be chosen independently for the work top and the sink, the work top and the sink can have different features such as color, pattern, material and surface form and therefore their appearances can be improved.

Although the present invention has been described with reference to the preferred embodiment while referring to the accompanying drawings, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

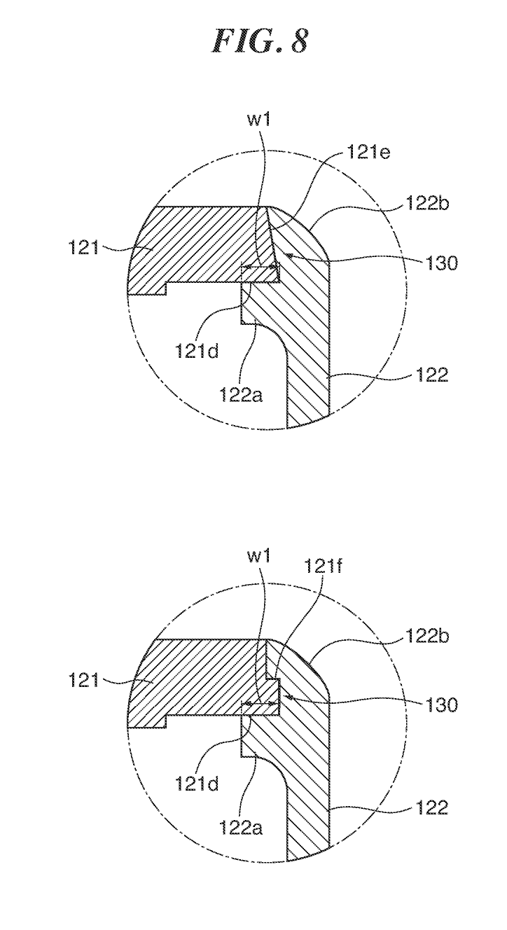

For example, FIG. 8 shows a view for illustrating variations of the work top 121. In FIG. 7, the end part 121c of the opening 121a of the work top 121 is formed almost perpendicular to the outside of the work top 121. However, the end part of the opening 121a may also be formed, as shown in the upper side of FIG. 8, as a slope 121e inclined to the outside of the work top 121. In addition, the end part of the opening 121a may also be formed, as shown in the lower side of FIG. 8, as a step part 121f.

It is preferable that the slope 121e and the step part 121f have a shape such that as it goes its lower side (sink-side), the area of the opening 121a becomes narrower. This feature can, in cooperation with the inside peripheral edge 121d, secure the material resins of the work top 121 and the sink 122 more tightly. Therefore, the mechanical strength of the work top can be improved. According to the feature, since the slope 121e and the step part 121f have a shape such that as it goes its upper side (outside), it retreats. Therefore, the thickness of the sink is not so thin and the upper end 122b of the sink 122 can be inclined remarkably as if it is chamfered. Accordingly, the upper end 122b of the sink can be smoothly continuous to the outside of the work top 121 and appearance, cleaning convenience and handling easiness of the sink can be improved.

Although the above embodiment is a work top with sink for a system kitchen, the present invention can be widely applied to a resin product provided with a first plate-like section and a second section attached to an opening formed in the first section, and to a manufacturing process of such a resin product as a bathtub, sink, washstand, waterproof pan.

The present invention can be applied to a manufacturing process of work top with sink which forms a part of a system kitchen, especially to the process for forming and joining a work top and a sink together as one body.

1. (canceled)

2. (canceled)

3. (canceled)

4. (canceled)

5. (canceled)

6. (canceled)

7. (canceled)

8. (canceled)

9. (canceled)

10. (canceled)

11. A process to manufacture a work top-sink assembly comprising a work top and a sink stuck together, the process comprising:
forming the work top, wherein the work top defines a sink opening formed in the work top; and
forming the sink comprising
attaching a sink-forming uneven mold to the work top at the sink opening; and
injecting a resin into the sink-forming uneven mold whereby the sink is formed and simultaneously stuck to the sink opening.

12. The process of claim 11, wherein the step of forming the sink further comprises nipping at a peripheral edge of the sink opening by the sink-forming uneven mold.

13. The process of claim 12, wherein the step of attaching the sink-forming uneven mold to the work top at the sink opening comprises:
directly attaching a convex mold to an outside portion of the work top; and
attaching a concave mold, via a sealing element to prevent a resin leak, to an inside portion of the work top.

14. The process of claim 13, wherein the step of forming the sink further comprises positioning a sink-side end of the sealing element at least 1 mm from the sink opening.

15. The process of claim 13, wherein the step of forming the work top comprises cutting at an inside peripheral edge of the sink opening to a thickness such that the work top and the sink are approximately equal in thickness and are flat at the inside peripheral edge.

16. A work top-sink assembly comprising:
a work top defining a sink opening having an inside peripheral edge formed in the work top; and
a sink comprising a resin directly attached to the work top at the inside peripheral edge.

17. The assembly of claim 16, wherein the sink further comprising a flange at the inside peripheral edge.

18. The assembly of claim 16, wherein the work top and the sink are approximately equal in thickness and are flat at the inside peripheral edge.

19. The assembly of claim 17, wherein the work top and the sink are approximately equal in thickness and are flat at the inside peripheral edge.

20. The assembly of claim 16, wherein the sink has at least one feature, selected from color, pattern, material and surface form, different from that of the work top.

21. The assembly of claim 17, wherein the sink has at least one feature, selected from color, pattern, material and surface form, different from that of the work top.

22. The assembly of claim 18, wherein the sink has at least one feature, selected from color, pattern, material and surface form, different from that of the work top.

23. The assembly of claim 16, wherein the sink has at least one feature, selected from color, pattern, material and surface form, common with that of the work top.

24. The assembly of claim 17, wherein the sink has at least one feature, selected from color, pattern, material and surface form, common with that of the work top.

25. The assembly of claim 18, wherein the sink has at least one feature, selected from color, pattern, material and surface form, common with that of the work top.
